(19) United States
(12) Patent Application Publication
(10) Pub. No.: US 2012/0080248 A1
(43) Pub. Date: Apr. 5, 2012

(54) Vehicle drive device

(75) Inventors: Satoru Kasuya, Nishio (JP); Masashi Kitou, Anjo (JP); Yuichi Seki, Okazaki (JP); Yusuke Takahashi, Anjo (JP); Shigeru Sugisaka, Nishio (JP)

(73) Assignee: AISIN AW CO., LTD., Anjo-shi (JP)

(21) Appl. No.: 13/137,887

(22) Filed: Sep. 20, 2011

(30) Foreign Application Priority Data
Sep. 24, 2010 (JP) 2010-213447
Feb. 28, 2011 (JP) 2011-043270

(51) Int. Cl. B60K 6/20

(52) U.S. Cl. 180/65.21; 903/902

(57) ABSTRACT

A vehicle drive device configured with an input member drivably coupled to an internal combustion engine. The drive device is also configured with an output member drivably coupled to wheels, a friction engagement device that selectively drivably couples the input member and the output member to each other, and a rotary electric machine provided on a power transfer path connecting between the input member and the output member. On the vehicle drive device, a housing oil chamber houses at least friction members of the friction engagement device and is filled with oil, a housing space houses the rotary electric machine, and there exists a first oil passage through which oil is supplied to the housing oil chamber. There is also a second oil passage through which oil is discharged from the housing oil chamber and a third oil passage through which oil is supplied to the housing space.

The disclosure of Japanese Patent Applications No. 2010-213447 filed on Sep. 24, 2010 and No. 2011-043270 filed on Feb. 28, 2011 including the specification, drawings and abstract is incorporated herein by reference in its entirety.

### BACKGROUND OF THE INVENTION

The present invention relates to a vehicle drive device including an input member drivably coupled to an internal combustion engine, an output member drivably coupled to wheels, a friction engagement device that selectively drivably couples the input member and the output member to each other, and a rotary electric machine provided on a power transfer path connecting between the input member and the output member.

### DESCRIPTION OF THE RELATED ART

A device disclosed in Japanese Patent Application Publication No. JP-A-2009-72052 mentioned below is already known as an example of a vehicle drive device including an input member drivably coupled to an internal combustion engine, an output member drivably coupled to wheels, a friction engagement device that selectively drivably couples the input member and the output member to each other, and a rotary electric machine provided on a power transfer path connecting between the input member and the output member. In the vehicle drive device, as shown in FIG. 3 of JP-A-2009-72052, oil having cooled friction members (friction plates and plates mated therewith) of the friction engagement device is supplied to an oil passage formed inside a rotor of the rotary electric machine so that the oil can cool permanent magnets provided in the rotary electric machine when the oil flows through the oil passage. Thereafter, the oil is supplied to coil end portions of the rotary electric machine so that the oil can cool the coil end portions. The coil end portions are also cooled by oil that overflows to detour through the axially outer side of the friction members. This allows both the friction members and the rotary electric machine to be cooled.

In the vehicle drive device according to JP-A-2009-72052, the friction members of the friction engagement device are disposed in a space that is open in the axial direction, and the open space and a housing space that houses the rotary electric machine are formed integrally with each other without any boundary therebetween. In such a configuration, in order to secure sufficient capability to cool the friction members, it is necessary to supply a large amount of oil to the friction members, which requires a large oil pump, however. As a result, not only energy for driving the pump is increased but also the weight of the oil pump itself is increased, which may reduce the energy efficiency.

### SUMMARY OF THE INVENTION

In view of the foregoing, it is desirable to provide a vehicle drive device in which both friction members and a rotary electric machine can be efficiently cooled while suppressing the amount of oil supplied to the friction members to be small.

A first aspect of the present invention provides a vehicle drive device including an input member drivably coupled to an internal combustion engine; an output member drivably coupled to wheels; a friction engagement device that selectively drivably couples the input member and the output member to each other; a rotary electric machine provided on a power transfer path connecting between the input member and the output member; a housing oil chamber that houses at least friction members of the friction engagement device and that is filled with oil; a housing space that houses the rotary electric machine; a first oil passage through which oil is supplied to the housing oil chamber; a second oil passage through which oil is discharged from the housing oil chamber; and a third oil passage through which oil is supplied to the housing space.

The term “rotary electric machine” as used herein refers to any of a motor (electric motor), a generator (electric generator), and a motor generator that functions both as a motor and as a generator as necessary.

The term “drivably coupled” refers to a state in which two rotary elements are coupled to each other in such a way that enables transfer of a drive force, which includes a state in which the two rotary elements are coupled to each other so as to rotate together with each other, and a state in which the two rotary elements are coupled to each other via one or two or more transmission members in such a way that enables transfer of a drive force. Examples of such transmission members include various members that transfer rotation at an equal speed or a changed speed, such as a shaft, a gear mechanism, a belt, and a chain.

According to the first aspect described above, oil at a relatively low temperature can be supplied to the rotary electric machine housed in the housing space through the third oil passage exclusively for supplying oil to the housing space. Accordingly, the rotary electric machine can be effectively cooled. In addition, the housing oil chamber is filled with oil, which is supplied to and discharged from the housing oil chamber through the first oil passage and the second oil passage, respectively. Thus, the friction members can be sufficiently cooled by an amount of oil that may fill at least the housing oil chamber and the first oil passage. That is, it is only necessary to supply a reduced amount of oil in order to secure sufficient capability to cool the friction plate.

Thus, according to the first aspect described above, it is possible to provide a vehicle drive device in which both the friction members and the rotary electric machine can be efficiently cooled while suppressing the amount of oil supplied to the friction members to be small.

According to a second aspect of the present invention, the third oil passage may be formed to be branched from the first oil passage.

According to the second aspect, oil is supplied to the rotary electric machine housed in the housing space through the third oil passage branched from the first oil passage through which oil is supplied to the housing oil chamber. Accordingly, oil can be supplied to the rotary electric machine not via the friction members of the friction engagement device. That is, the rotary electric machine can be supplied with oil at about the same temperature as oil supplied to the housing oil chamber, which makes it possible to effectively cool both the friction members and the rotary electric machine utilizing oil at a relatively low temperature.

According to a third aspect of the present invention, the vehicle drive device may further include a case that houses at least the rotary electric machine and the friction engagement device. In the vehicle drive device, a rotor of the rotary electric machine may be disposed radially inwardly of a stator of the rotary electric machine, the third oil passage may be provided in the case, and include a third oil passage opening portion that opens inside the case, and the third oil passage opening portion may be positioned radially inwardly of an outer peripheral surface of the rotor of the rotary electric machine.

According to the third aspect, the third oil passage opening portion is positioned radially inwardly of the outer peripheral surface of the rotor. Thus, oil from the third oil passage can be easily supplied to the rotor via the third oil passage opening portion. The oil supplied to the rotor is splashed radially outward by a centrifugal force due to rotation of the rotor. Thus, the oil can be supplied to the stator to also cool the stator.

Thus, according to the third aspect described above, it is possible to provide a vehicle drive device in which both the stator and the rotor of the rotary electric machine can be effectively cooled.

According to a fourth aspect of the present invention, the vehicle drive device may further include a speed change mechanism disposed coaxially with the rotary electric machine and side by side with the rotary electric machine in an axial direction, and a hydraulic pressure control device disposed at a position overlapping the speed change mechanism as seen from a radial direction. In the vehicle drive device, the case may include a partition wall extending in a radial direction of the rotary electric machine for partitioning between the rotary electric machine and the speed change mechanism, the first oil passage may allow communication from the hydraulic pressure control device to the housing oil chamber, and the third oil passage opening portion may be provided in the partition wall.

The phrase “overlap as seen in a predetermined direction” as used for the arrangement of two members means that when the viewing direction is determined as the predetermined direction and the viewpoint is moved in directions orthogonal to the viewing direction, the two members are seen as overlapping each other from at least some positions of the viewpoint.

According to the fourth aspect, the third oil passage opening portion is provided in the partition wall positioned relatively close to the hydraulic pressure control device and disposed adjacent to the rotary electric machine. Thus, the distance from the hydraulic pressure control device to the third oil passage opening portion can be shortened compared to a case where the third oil passage opening portion is provided at different positions of the case. This enables an oil passage from the hydraulic pressure control device to the third oil passage opening portion to be shortened. Thus, the number of seal portions provided at a joint of the case or the like can be reduced, and the configuration of the oil passage can be simplified. According to the fourth aspect, oil controlled to a desired hydraulic pressure by the hydraulic pressure control device can be supplied to the housing oil chamber via the first oil passage.

According to a fifth aspect of the present invention, the vehicle drive device may further include an oil collection portion provided in the rotor or a support member for the rotor, and a fourth oil passage through which oil is supplied from the oil collection portion to a coil end portion of the rotary electric machine. In the vehicle drive device, the third oil passage opening portion may be positioned radially inwardly of the oil collection portion.

According to the fifth aspect, oil supplied from the third oil passage opening portion is collected by the oil collection portion, and thereafter supplied to the coil end portion of the stator via the fourth oil passage. Accordingly, oil can be reliably supplied to the coil end portion to cool the coil end portion. Accordingly, the rotary electric machine can be more effectively cooled.

According to a sixth aspect of the present invention, the vehicle drive device may further include a housing which surrounds the friction engagement device from both sides in the axial direction and from an outer side in the radial direction and in which the housing oil chamber is formed. In the vehicle drive device, the housing may also serve as a support member for the rotor of the rotary electric machine, and includes an axially projecting portion that has a shape of a cylinder and projects in the axial direction, an outer peripheral surface of the axially projecting portion may be rotatably supported by a first bearing, and an inner peripheral surface of the axially projecting portion may be rotatably supported by a second bearing with a seal, the second bearing may be disposed such that a surface of the second bearing on one side in the axial direction communicates with the second oil passage, and a fifth oil passage through which oil having passed through the second bearing and leaked out to the other side in the axial direction is supplied to the first bearing may be provided on the other side of the second bearing in the axial direction.

According to the sixth aspect, oil flowing through the second oil passage and having passed through the second bearing is supplied to the first bearing through the fifth oil passage. Accordingly, the first bearing can be conveniently lubricated and cooled while cooling the friction engagement device and the rotary electric machine.

In the configuration in which the partition wall includes a radial wall portion formed integrally with the case and a pump case that houses an oil pump, the radial wall portion extends radially inward from an outer peripheral wall portion of the case, and includes a center opening portion that penetrates through the radial wall portion in the axial direction to open at a radially central portion of the radial wall portion, and the pump case includes a body portion disposed to be inserted into the center opening portion, and a radially extending portion extending in the radial direction on a side opposite the rotary electric machine with respect to the radial wall portion, the third oil passage and the third oil passage opening portion for supplying oil to the rotary electric machine may be configured as follows.

For example, according to a seventh aspect of the present invention, the third oil passage and the third oil passage opening portion may be provided in the radially extending portion, and the third oil passage opening portion opens toward a side of the rotary electric machine, and a supply communication hole that allows oil to be discharged from the third oil passage opening portion and be supplied toward the side of the rotary electric machine may be formed to penetrate through the radial wall portion at a position overlapping the third oil passage opening portion as seen in an axial direction of the rotary electric machine.

According to an eighth aspect of the present invention, alternatively, the third oil passage may be provided across the radially extending portion and the body portion, and the third oil passage opening portion may be provided at a portion of the body portion on a side of the rotary electric machine with respect to the radial wall portion to open radially outward.

According to a ninth aspect of the present invention, still alternatively, the third oil passage and the third oil passage opening portion may be provided in the radial wall portion, and the third oil passage opening portion may open toward a side of the rotary electric machine.

### BRIEF DESCRIPTION OF THE DRAWINGS

FIG. 1 is a cross-sectional view showing an essential portion of a hybrid drive device according to an embodiment;

FIG. 2 is a schematic diagram showing a schematic configuration of the hybrid drive device according to the embodiment;

FIG. 3 is a schematic diagram showing a pump case according to the embodiment as seen from the side of an internal combustion engine;

FIG. 4 is a schematic cross-sectional view of the hybrid drive device according to the embodiment;

FIG. 5 is a graph showing the effect of cooling a clutch in the hybrid drive device according to the embodiment;

FIG. 6 is a cross-sectional view showing an essential portion of a hybrid drive device according to another embodiment, showing an exemplary configuration of a third oil passage;

FIG. 7 is a cross-sectional view showing an essential portion of a hybrid drive device according to another embodiment, showing an exemplary configuration of the third oil passage;

FIG. 8 is a cross-sectional view showing an essential portion of a hybrid drive device according to another embodiment, showing an exemplary configuration of the third oil passage; and

FIG. 9 is a cross-sectional view showing an essential portion of a hybrid drive device according to another embodiment, showing an exemplary configuration of the third oil passage.

### DETAILED DESCRIPTION OF THE EMBODIMENT

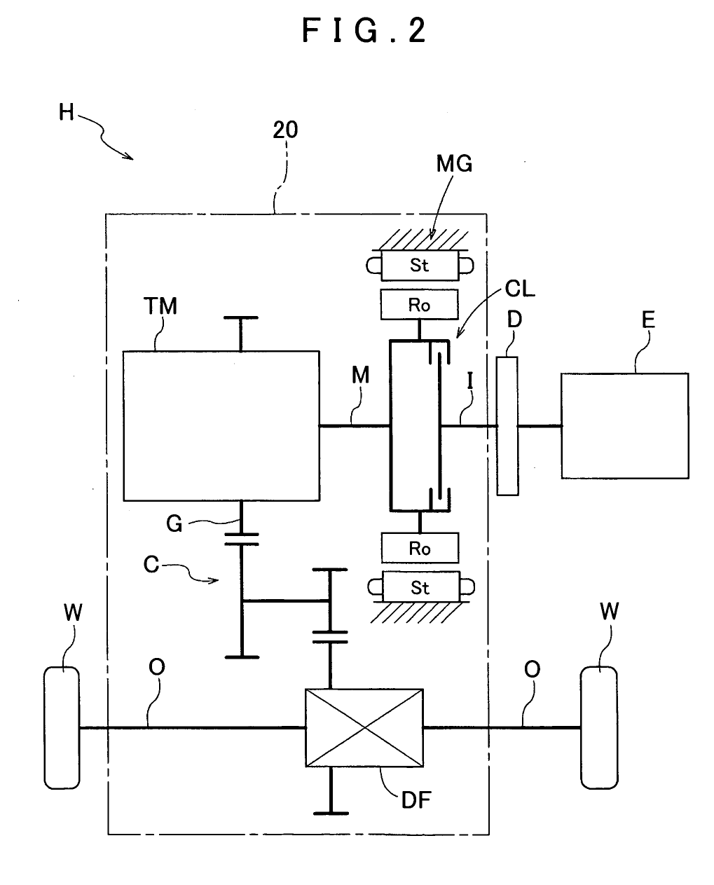

An embodiment of the present invention will be described with reference to the drawings. In the embodiment, a vehicle drive device according to the present invention is applied to a hybrid drive device. FIG. 2 is a schematic diagram showing a schematic configuration of a hybrid drive device H according to the embodiment. The hybrid drive device H is a drive device for a hybrid vehicle that uses one or both of an internal combustion engine E and a rotary electric machine MG as a drive force source for the vehicle. The hybrid drive device H is formed as a so-called one-motor parallel type hybrid drive device. The hybrid drive device H according to the embodiment will be described in detail below.

### 1. Overall Configuration of Hybrid Drive Device

First, the overall configuration of the hybrid drive device H according to the embodiment will be described. As shown in FIG. 2, the hybrid drive device H includes an input shaft I drivably coupled to the internal combustion engine E serving as a first drive force source for the vehicle, the rotary electric machine MG serving as a second drive force source for the vehicle, a speed change mechanism TM, an intermediate shaft M drivably coupled the rotary electric machine MG and drivably coupled to the speed change mechanism TM, and output shafts O drivably coupled to wheels W. The hybrid drive device H also includes a clutch CL provided to switch on and off transfer of a drive force between the input shaft I, and the intermediate shaft M and the output shafts O, a counter gear mechanism C, and an output differential gear device DF. The rotary electric machine MG is provided on a power transfer path connecting between the input shaft I and the output shafts O. In the example, the rotary electric machine MG is drivably coupled to the output shafts O via the intermediate shaft M, the speed change mechanism TM, the counter gear mechanism C, and the output differential gear device DF. These components are housed in a case (drive device case) 20.

In the embodiment, the “axial direction”, the “radial direction”, and the “circumferential direction” are prescribed with reference to the rotational axes of the input shaft I, the intermediate shaft M, and the rotary electric machine MG, which are disposed coaxially with each other. The term “drive force” is used as a synonym for torque.

The internal combustion engine E is a device driven by combusting fuel inside the engine to take out power. Various engines known in the art such as a gasoline engine and a diesel engine, for example, may be used as the internal combustion engine E. In the example, an output rotary shaft such as a crankshaft of the internal combustion engine E is drivably coupled to the input shaft I via a damper D. The input shaft I is drivably coupled to the rotary electric machine MG and the intermediate shaft M via the clutch CL. The input shaft I is selectively drivably coupled to the rotary electric machine MG and the intermediate shaft M through the clutch CL. When the clutch CL is in the engaged state, the internal combustion engine E and the rotary electric machine MG are drivably coupled to each other via the input shaft I. When the clutch CL is in the disengaged state, the internal combustion engine E and the rotary electric machine MG are decoupled from each other. In the embodiment, the input shaft I functions as the “input member” according to the present invention.

The rotary electric machine MG includes a stator St and a rotor Ro, and can function both as a motor (electric motor) that is supplied with electric power to generate power and as a generator (electric generator) that is supplied with power to generate electric power. Therefore, the rotary electric machine MG is electrically connected to an electricity accumulation device (not shown). In the example, a battery is used as the electricity accumulation device. A capacitor or the like may also be suitably used as the electricity accumulation device. The rotary electric machine MG is supplied with electric power from the battery to perform power running, or supplies electric power generated using torque output from the internal combustion engine E or an inertial force of the vehicle to the battery to accumulate the electric power. The rotor Ro of the rotary electric machine MG is drivably coupled to the intermediate shaft M so as to rotate together with the intermediate shaft M. The intermediate shaft M serves as an input shaft of the speed change mechanism TM (transmission input shaft).

The speed change mechanism TM is a device that transfers rotation of the intermediate shaft M to the transmission output gear G while changing the rotational speed with a predetermined speed ratio. In the embodiment, a stepped automatic transmission including single-pinion type and Ravigneaux type planetary gear mechanisms and a plurality of engagement devices such as a clutch, a brake, and a one-way clutch to switchably provide a plurality of shift speeds with different speed ratios is used as the speed change mechanism TM. A stepped automatic transmission with other specific configurations, an automatic continuously variable transmission with continuously variable speed ratios, a stepped manual transmission that switchably provides a plurality of shift speeds with different speed ratios, or the like may also be used as the speed change mechanism TM. The speed change mechanism TM transfers rotation and torque of the intermediate shaft M to the transmission output gear G while changing the rotational speed at a predetermined speed ratio at each timing and converting torque.

The transmission output gear G is drivably coupled to the output differential gear device DF via the counter gear mechanism C. The output differential gear device DF is drivably coupled to the wheels W via the output shafts O to split rotation and torque input to the output differential gear device DF to transfer the split rotation and torque to the two, left and right, wheels W. This allows the hybrid drive device H to transfer torque of one or both of the internal combustion engine E and the rotary electric machine MG to the wheels W to run the vehicle. In the embodiment, the output shafts O functions as the “output member” according to the present invention.

In the hybrid drive device H according to the embodiment, the input shaft I and the intermediate shaft M are disposed coaxially with each other, and the output shafts O are disposed in parallel with each other and non-coaxially with the input shaft I and the intermediate shaft M, forming a multi-axis configuration. Such a configuration is suitable for the hybrid drive device H to be mounted on a FF (Front-Engine Front-Drive) vehicle, for example.

### 2. Configuration of Various Components of Hybrid Drive Device

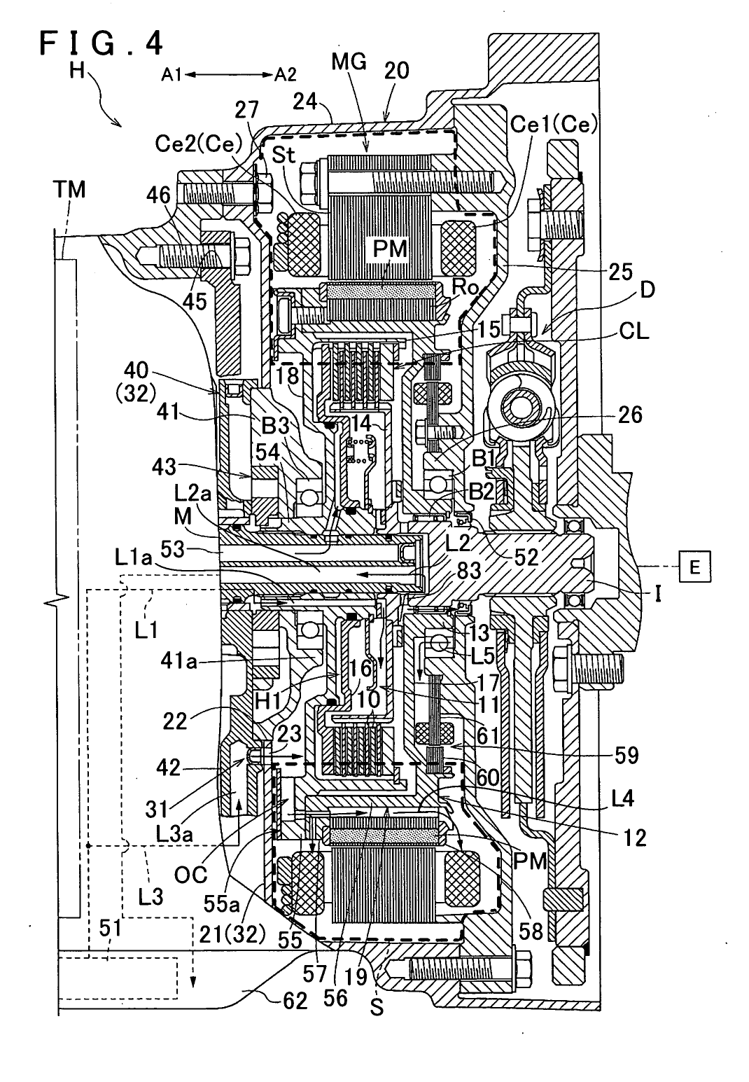

Next, the configuration of various components of the hybrid drive device H according to the embodiment will be described. As shown in FIG. 4, the case 20 houses at least the rotary electric machine MG, the clutch CL, and the speed change mechanism TM. The case 20 includes a case peripheral wall 24 that covers the outer peripheries of components housed in the case 20 such as the rotary electric machine MG and the speed change mechanism TM, a first support wall 25 that blocks an opening of the case peripheral wall 24 on the side in a second axial direction A2 (on the side of the internal combustion engine E and on the right side in FIG. 4; the same applies hereinafter), and a second support wall 32 provided on the side in a first axial direction A1 with respect to the first support wall 25 (on the side opposite the internal combustion engine E and on the left side in FIG. 4; the same applies hereinafter) and disposed between the rotary electric machine MG and the speed change mechanism TM in the axial direction. Although not shown, the case 20 further includes an end portion support wall that closes an end portion of the case peripheral wall 24 on the side in the first axial direction A1. In the embodiment, the case peripheral wall 24 functions as the “outer peripheral wall portion” according to the present invention. A hydraulic pressure control device 51 is disposed in the case 20 vertically below the speed change mechanism TM. The hydraulic pressure control device 51 is disposed at a position overlapping the speed change mechanism TM as seen from the radial direction. Specifically, an oil pan 62 is attached to the lower surface of the case 20 vertically below the speed change mechanism TM, and the hydraulic pressure control device 51 is provided in a space surrounded by the lower surface of the case 20 and the oil pan 62.

The first support wall 25 is shaped to extend at least in the radial direction. In the embodiment, the first support wall 25 extends in the radial direction and the circumferential direction. A through hole in the axial direction is formed in the first support wall 25. The input shaft I, which is inserted through the through hole, penetrates through the first support wall 25 to be inserted into the case 20. The first support wall 25 is coupled to a cylindrical portion 26 that has the shape of a boss projecting toward the first axial direction A1. The cylindrical portion 26 is integrally coupled to the first support wall 25. The first support wall 25 is disposed on the side in the second axial direction A2 with respect to the rotary electric machine MG and the clutch CL. More specifically, the first support wall 25 is disposed adjacently with a predetermined clearance on the side in the second axial direction A2 with respect to a rotor support member 12 that supports the rotor Ro of the rotary electric machine MG. In addition, the first support wall 25 rotatably supports the rotor support member 12 on the side in the second axial direction A2 with respect to the rotary electric machine MG.

The second support wall 32 is shaped to extend at least in the radial direction. In the embodiment, the second support wall 32 extends in the radial direction and the circumferential direction. A through hole in the axial direction is formed in the second support wall 32. The intermediate shaft M, which is inserted through the through hole, penetrates through the second support wall 32. The second support wall 32 is disposed on the side in the first axial direction A1 with respect to the rotary electric machine MG and the clutch CL. More specifically, the second support wall 32 is disposed adjacently with a predetermined clearance on the side in the first axial direction A1 with respect to the rotor support member 12. In addition, the second support wall 32 rotatably supports the rotor support member 12 on the side in the first axial direction A1 with respect to the rotary electric machine MG. In the embodiment, the second support wall 32 functions as the “partition wall” according to the present invention.

Here, the second support wall 32 includes a radial wall portion 21 formed integrally with the case 20 and a pump case 40 that houses an oil pump 43. The pump case 40 includes a body portion 41 and a radially extending portion 42.

The radial wall portion 21 is a part of the case 20. The radial wall portion 21 extends radially inward from the case peripheral wall 24, and extends in the circumferential direction. A center opening portion 22 into which the body portion 41 of the pump case 40 can be inserted is formed in the radially central portion of the radial wall portion 21. The radial wall portion 21 is disposed between the rotor support member 12 and the radially extending portion 42 of the pump case 40 in the axial direction. That is, the radial wall portion 21 is disposed on the side in the first axial direction A1 with respect to the rotor support member 12 and on the side in the second axial direction A2 with respect to the radially extending portion 42. The case 20 is divided into two portions, namely a first case portion that houses the rotary electric machine MG, the clutch CL, and so forth and a second case portion that houses the speed change mechanism TM and so forth, with the radial wall portion 21 serving as the boundary. These portions are fastened to each other by bolts 27 provided at the outer peripheral portion of the radial wall portion 21.

The pump case 40 includes the body portion 41 which is inserted through the center opening portion 22 to be disposed radially inwardly of the radial wall portion 21, and the radially extending portion 42 extending in the radial direction on the side in the first axial direction A1, which is the side opposite the rotary electric machine MG with respect to the radial wall portion 21. The radially extending portion 42 has a circular recessed portion formed in its side surface on the side in the second axial direction A2 and having an inside diameter that is equal to the inside diameter of the center opening portion 22. The recessed portion is disposed adjacent to the center opening portion 22 in the axial direction. The body portion 41 is joined to the radially extending portion 42 with the side surface of the body portion 41 on the side in the first axial direction A1 contacting the side surface of the recessed portion of the radially extending portion 42 on the side in the second axial direction A2. A pump chamber is formed between the body portion 41 and the radially extending portion 42. The oil pump 43 is disposed in the pump chamber. Moreover, a through hole in the axial direction is formed in the pump case 40 (the body portion 41 and the radially extending portion 42). The intermediate shaft M, which is inserted through the through hole, penetrates through the pump case 40.

The oil pump 43 is thus provided inside the second support wall 32. Accordingly, the oil pump 43 is provided between the speed change mechanism TM and the rotor support member 12, that is, between the speed change mechanism TM and the rotary electric machine MG, in the axial direction. The oil pump 43 is disposed coaxially with the input shaft I and the intermediate shaft M. In the embodiment, in addition, the rotor support member 12 is also disposed coaxially with the input shaft I and the intermediate shaft M. Accordingly, the oil pump 43 can be said to be disposed coaxially with the rotor support member 12 and on the side in the first axial direction A1 with respect to the rotor support member 12.

In the embodiment, the oil pump 43 is an internal gear pump having an inner rotor and an outer rotor. The inner rotor of the oil pump 43 is splined, at the radially central portion of the inner rotor, to the rotor support member 12 so as to rotate together with the rotor support member 12. The oil pump 43 sucks oil from the oil pan 62 along with rotation of the rotor support member 12, and discharges the sucked oil to supply the oil to the clutch CL, the speed change mechanism TM, the rotary electric machine MG, and so forth. Oil passages are formed inside the second support wall 32, the intermediate shaft M, and so forth. The oil discharged from the oil pump 43 flows via the hydraulic pressure control device 51 and these oil passages to be supplied to each of the portions to which oil is to be supplied. The oil supplied to the portions lubricates and/or cools these portions. In the embodiment, oil functions as a “lubricating/cooling liquid” that may function both as a “lubricant” and as a “coolant”.

The body portion 41 of the pump case 40 is an annular plate member extending in the radial direction and the circumferential direction, and integrally includes an axially projecting portion 41a that has the shape of a cylinder (boss) projecting toward the second axial direction A2. The body portion 41 is shaped to swell in a Cylindrical shape as a whole on the side in the second axial direction A2, and shaped to project toward the second axial direction A2, that is, toward the rotor support member 12 and the rotary electric machine MG, in the axial direction. The axially projecting portion 41a is disposed on the side in the second axial direction A2 with respect to an oil collection portion OC to be discussed later provided in the rotor support member 12. That is, the body portion 41 and the oil collection portion OC partially overlap each other as seen in the radial direction. A recessed portion for forming the pump chamber which houses the oil pump 43 is formed in the body portion 41 on the side in the first axial direction A1 so as to have a circular cross section as seen from the axial direction.

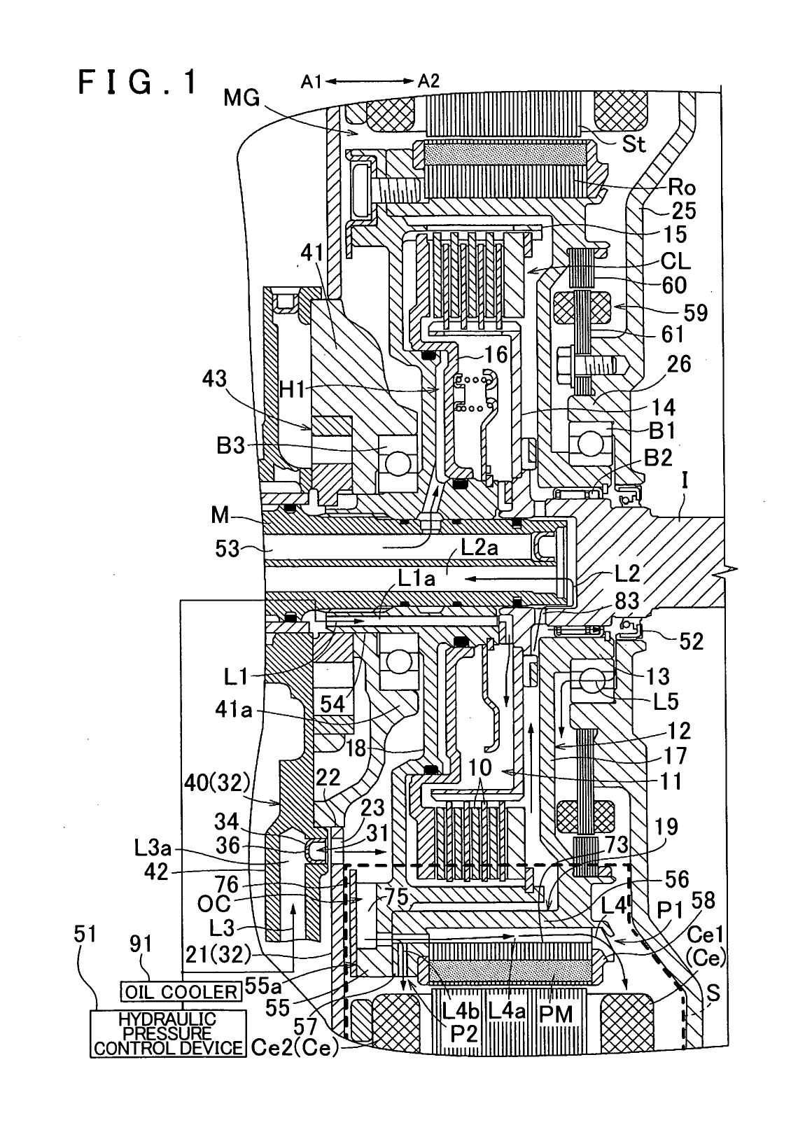

As shown in FIG. 1, the body portion 41 is positioned in the radial direction by fitting the outer peripheral surface of the body portion 41 with the inner peripheral surface of the center opening portion 22 of the radial wall portion 21. Specifically, the body portion 41 is disposed such that the outer peripheral surface of the body portion 41 and the inner peripheral surface of the center opening portion 22 face each other with a seal member (not shown) interposed between the outer peripheral surface of the body portion 41 and the inner peripheral surface of the center opening portion 22. That is, the body portion 41 is oil-tightly fitted with the radial wall portion 21 via the seal member to be held in position.

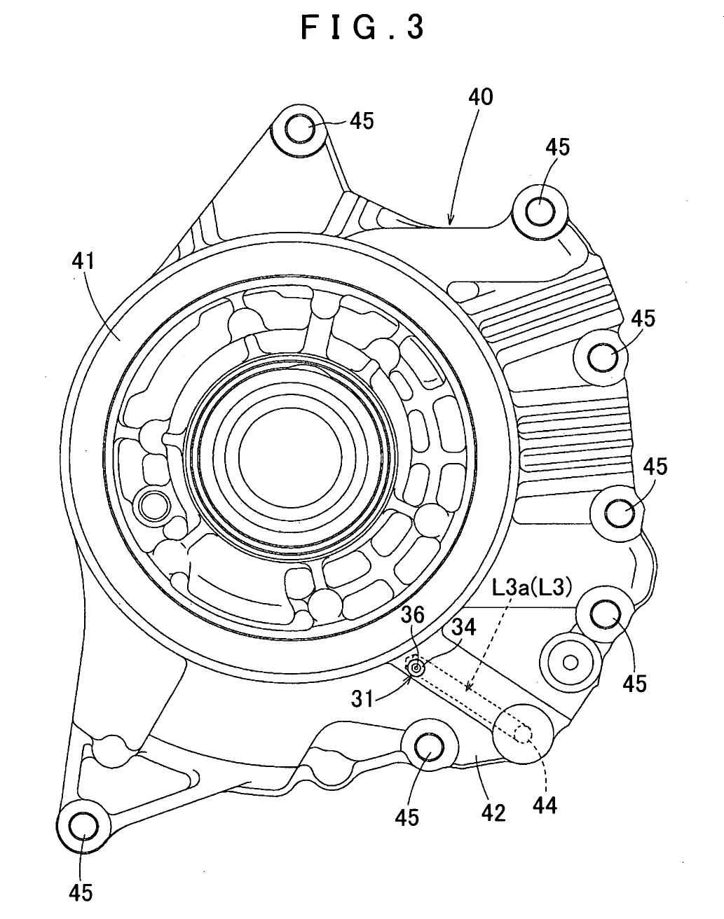

The radially extending portion 42 of the pump case 40 is a generally annular plate member extending in the radial direction and the circumferential direction. In the embodiment, the body portion 41 and the radially extending portion 42 are fixed to each other by fastening bolts (not shown). As shown in FIG. 3, the radially extending portion 42 is provided with through holes 45 (in the example, seven through holes 45) distributed in the circumferential direction. As shown in FIG. 4, the radially extending portion 42 is fastened and fixed to the case 20 via bolts 46 inserted through the respective through holes 45.

As shown in FIG. 1, the radially extending portion 42 is disposed on the side in the first axial direction A1 with respect to the radial wall portion 21 and the body portion 41. The radially extending portion 42 and the radial wall portion 21 partially overlap each other as seen in the axial direction. That is, the radially extending portion 42 partially overlaps the center opening portion 22 as seen in the axial direction, and extends further radially outwardly of the inner peripheral surface of the center opening portion 22.

In the embodiment, the radially extending portion 42 is provided with an oil supply passage L3a and a third oil passage opening portion 31. The oil supply passage L3a is a part of a third oil passage L3 to be discussed later. The oil supply passage L3a is formed to extend in the radial direction in (inside) the radially extending portion 42. The third oil passage opening portion 31 opens toward the side of the rotary electric machine MG in the axial direction, that is, toward the second axial direction A2. Further, a supply communication hole 23 that penetrates through the radial wall portion 21 in the axial direction is formed in the radial wall portion 21 at a position overlapping the third oil passage opening portion 31 as seen in the axial direction. These components will be discussed in detail later.

The input shaft I is a shaft member used to input torque of the internal combustion engine E to the hybrid drive device H. As shown in FIG. 4, the input shaft I is drivably coupled to the internal combustion engine E at an end portion of the input shaft I on the side in the second axial direction A2. The input shaft I is disposed to penetrate through the first support wall 25. The input shaft I is drivably coupled to the output rotary shaft of the internal combustion engine E via the damper D at a location on the side in the second axial direction A2 with respect to the first support wall 25 so as to rotate together with the output rotary shaft. A seal member 52 is disposed between the outer peripheral surface of the input shaft I and the inner peripheral surface of the through hole provided in the first support wall 25 to suppress leakage of oil toward the side in the second axial direction A2 (toward the side of the damper D) by liquid-tightly sealing an area between the outer peripheral surface of the input shaft I and the inner peripheral surface of the through hole.

In the embodiment, a hole portion extending in the axial direction is formed in the radially central portion of an end portion of the input shaft I on the side in the first axial direction A1. An end portion of the intermediate shaft M, which is disposed coaxially with the input shaft I, on the side in the second axial direction A2 is inserted into the hole portion. An end portion of the input shaft I on the side in the first axial direction A1 is coupled to a clutch hub 14 extending radially outward. In the embodiment, the rotor support member 12 is formed to cover the periphery of the clutch CL as discussed later, and the rotor support member 12 forms a housing that houses the clutch CL (clutch housing). In the example, all of the rotor support member 12 is utilized to form the housing. The term “rotor support member 12” as used hereinafter also includes the meaning of “housing”.

The intermediate shaft M is a shaft member used to input one or both of torque of the rotary electric machine MG and torque of the internal combustion engine E via the clutch CL to the speed change mechanism TM. The intermediate shaft M is splined to the rotor support member 12. As shown in FIG. 4, the intermediate shaft M is disposed to penetrate through the second support wall 32. As described above, a through hole in the axial direction is formed in the radially central portion of the second support wall 32, and the intermediate shaft M penetrates through the second support wall 32 via the through hole. The intermediate shaft M is supported in the radial direction so as to be rotatable with respect to the second support wall 32. In the embodiment, a plurality of oil passages including a working oil passage 53 and an oil discharge passage L2a are formed inside the intermediate shaft M. The oil discharge passage L2a is a part of a second oil passage L2 to be discussed later. The working oil passage 53 extends in the axial direction, and extends in the radial direction at a predetermined position in the axial direction to open in the outer peripheral surface of the intermediate shaft M so as to communicate with a working oil chamber H1 of the clutch CL. The oil discharge passage L2a extends in the axial direction to open in an end surface of the intermediate shaft M on the side in the second axial direction A2.

The clutch CL is a friction engagement device provided to switch on and off transfer of a drive force between the input shaft I, and the intermediate shaft M and the output shafts O and to selectively drivably couple the internal combustion engine E and the rotary electric machine MG to each other as described above. The clutch CL functions to decouple the internal combustion engine E from the rotary electric machine MG and the output shafts O in an electric power travel mode (EV mode) in which only torque of the rotary electric machine MG is utilized to run the vehicle, for example. That is, the clutch CL functions as a friction engagement device that decouples the internal combustion engine. In the embodiment, the clutch CL is formed as a wet multi-plate clutch mechanism. As shown in FIG. 1, the clutch CL includes the clutch hub 14, a clutch drum 15, a plurality of friction plates 10, and a piston 16. The clutch hub 14 is coupled to an end portion of the input shaft I on the side in the first axial direction A1 so as to rotate together with the input shaft I. The clutch drum 15 is formed integrally with the rotor support member 12, and coupled to the intermediate shaft M via the rotor support member 12 so as to rotate together with the intermediate shaft M. The friction plates 10 are provided between the clutch hub 14 and the clutch drum 15, and include pairs of hub-side friction plates and drum-side friction plates. In the embodiment, the friction plates 10 functions as the “friction members” according to the present invention.

In the embodiment, the working oil chamber H1 which is liquid-tight is formed between the rotor support member 12, which is integrated with the clutch drum 15, and the piston 16. The working oil chamber H1 is supplied with oil, which has been discharged from the oil pump 43 and regulated to a predetermined hydraulic pressure by the hydraulic pressure control device 51, via the working oil passage 53 formed in the intermediate shaft M. Engagement and disengagement of the clutch CL is controlled in accordance with the hydraulic pressure supplied to the working oil chamber H1. An oil circulation chamber 11 is formed on the side opposite the working oil chamber H1 with respect to the piston 16. The oil circulation chamber 11 is supplied with oil, which has been discharged from the oil pump 43 and regulated to a predetermined hydraulic pressure by the hydraulic pressure control device 51, via an oil circulation passage L1a formed in the rotor support member 12. In the embodiment, the oil circulation passage L1a and an oil passage that allows communication from the hydraulic pressure control device 51 to an end portion of the oil circulation passage L1a on the side in the first axial direction A1 form the “first oil passage L1” according to the present invention.

As shown in FIG. 1, the rotary electric machine MG is disposed radially outwardly of the clutch CL. The rotary electric machine MG and the clutch CL are disposed to partially overlap each other as seen in the radial direction. Disposing the rotary electric machine MG and the clutch CL in such a positional relationship reduces the axial length, and hence the overall size, of the device.

As shown in FIG. 4, the rotary electric machine MG includes the stator St fixed to the case 20 and the rotor Ro supported radially inwardly of the stator St via the rotor support member 12 so as to be freely rotatable. The stator St and the rotor Ro are disposed to face each other in the radial direction via a minute gap. The stator St includes a stator core fixed to the first support wall 25 and formed as a laminated structure in which a plurality of magnetic steel sheets each formed in an annular plate shape are laminated on each other, and a coil wound around the stator core. Portions of the coil that project from end surfaces of the stator core on both sides in the axial direction serve as coil end portions Ce. In the example, of the coil end portions Ce on both sides in the axial direction, the coil end portion Ce on the side in the second axial direction A2 is defined as a first coil end portion Ce1, and the coil end portion Ce on the side in the first axial direction A1 is defined as a second coil end portion Ce2.

The rotor Ro of the rotary electric machine MG includes a rotor core formed as a laminated structure in which a plurality of magnetic steel sheets each formed in an annular plate shape are laminated on each other, and permanent magnets PM embedded in the rotor core. In the embodiment, the plurality of permanent magnets PM extending in the axial direction are distributed in the rotor Ro (rotor core) in the circumferential direction.

In the embodiment, the stator St and the rotor Ro of the rotary electric machine MG are housed in a rotary electric machine housing space S. The rotary electric machine housing space S is formed as an annular space formed coaxially with the input shaft I and the intermediate shaft M. A cross section of the rotary electric machine housing space S taken along a plane including the rotational axis of the input shaft I and the intermediate shaft M at least occupies a region between the first support wall 25 and the second support wall 32 (here, the radial wall portion 21) in the axial direction, and occupies a region between a radially inner end surface of the rotor Ro and the case peripheral wall 24 in the radial direction. In the embodiment, the above cross section of the rotary electric machine housing space S further occupies a region located radially outwardly of the third oil passage opening portion 31 in the radial direction. That is, the rotary electric machine housing space S is a space, of the space inside the first case portion forming the case 20, that is spread radially outwardly of the third oil passage opening portion 31. The rotary electric machine housing space S is formed along the outer peripheries of the stator St and the rotor Ro so as to surround the peripheries of the stator St and the rotor Ro. A gap between the stator St and the rotor Ro, and the case 20 (the first support wall 25, the radial wall portion 21, and the case peripheral wall 24) is a predetermined distance or less. In FIG. 4, a schematic range occupied by the rotary electric machine housing space S is indicated by the broken lines. In the embodiment, the rotary electric machine housing space S functions as the “housing space” according to the present invention.

As shown in FIGS. 1 and 4, the hybrid drive device H according to the embodiment includes the rotor support member 12 which supports the rotor Ro. In the embodiment, the rotor support member 12 functions as the “support member” according to the present invention. The rotor support member 12 supports the rotor Ro so as to be rotatable with respect to the case 20. More specifically, the rotor support member 12 is supported by the first support wall 25 via a first bearing B1 on the side in the second axial direction A2 and by the second support wall 32 via a third bearing B3 on the side in the first axial direction A1, with the rotor Ro fixed to the outer peripheral portion of the rotor support member 12. The rotor support member 12 is formed to cover the periphery, that is, the side in the first axial direction A1, the side in the second axial direction A2, and the radially outer side, of the clutch CL disposed inside the rotor support member 12. Therefore, the rotor support member 12 includes a first radially extending portion 17 disposed on the side in the second axial direction A2 with respect to the clutch CL to extend in the radial direction, a second radially extending portion 18 disposed on the side in the first axial direction A1 with respect to the clutch CL to extend in the radial direction, and an axially extending portion 19 disposed radially outwardly of the clutch CL to extend in the axial direction.

The first radially extending portion 17 is shaped to extend at least in the radial direction. In the embodiment, the first radially extending portion 17 extends in the radial direction and the circumferential direction. A through hole in the axial direction is formed in the radially central portion of the first radially extending portion 17. The input shaft I, which is inserted through the through hole, penetrates through the first radially extending portion 17 to be inserted into the rotor support member 12. In the example, in addition, the first radially extending portion 17 is formed in the shape of a plate as a whole, and has an offset shape in which the radially inner portion is positioned slightly on the side in the first axial direction A1 with respect to the radially outer portion. The first radially extending portion 17 is coupled to a cylindrical portion 13 that has the shape of a boss projecting toward the second axial direction A2. The cylindrical portion 13 is integrally coupled to the first radially extending portion 17 at a radially inner end portion of the first radially extending portion 17. The cylindrical portion 13 is formed to surround the periphery of the input shaft I. A second bearing B2 is disposed between the inner peripheral surface of the cylindrical portion 13 and the outer peripheral surface of the input shaft I. In addition, the first bearing B1 is disposed between the outer peripheral surface of the cylindrical portion 13 and the inner peripheral surface of the cylindrical portion 26 of the first support wall 25. In the example, a ball bearing is used as the first bearing B1. The first bearing B1 and the second bearing B2 are disposed so as to overlap each other as seen in the radial direction. In the embodiment, the cylindrical portion 13 functions as the “axially projecting portion” according to the present invention.

The second radially extending portion 18 is shaped to extend at least in the radial direction. In the embodiment, the second radially extending portion 18 extends in the radial direction and the circumferential direction. A through hole in the axial direction is formed in the radially central portion of the second radially extending portion 18. The intermediate shaft M, which is inserted through the through hole, penetrates through the second radially extending portion 18 to be inserted into the rotor support member 12. In the example, in addition, the second radially extending portion 18 is formed in the shape of a plate as a whole, and has an offset shape in which the radially inner portion is positioned on the side in the second axial direction A2 with respect to the radially outer portion. The second radially extending portion 18 is coupled to a cylindrical portion 54 that has the shape of a boss projecting at least toward the first axial direction A1. The cylindrical portion 54 is integrally coupled to the second radially extending portion 18 at a radially inner end portion of the second radially extending portion 18. The cylindrical portion 54 is formed to surround the periphery of the intermediate shaft M. The inner peripheral surface of a part of the cylindrical portion 54 in the axial direction abuts against the outer peripheral surface of the intermediate shaft M over the entire circumference. In addition, the third bearing B3 is disposed between the outer peripheral surface of the cylindrical portion 54 and the inner peripheral surface of the axially projecting portion 41a of the second support wall 32. In the example, a ball bearing is used as the third bearing B3.

The cylindrical portion 54 is splined to the intermediate shaft M at the inner peripheral portion of an end portion of the cylindrical portion 54 on the side in the first axial direction A1 so as to rotate together with the intermediate shaft M. The cylindrical portion 54 is also splined to the inner rotor forming the oil pump 43 at the outer peripheral portion of an end portion of the cylindrical portion 54 on the side in the first axial direction A1 so as to rotate together with the inner rotor. The working oil chamber H1 is formed between the second radially extending portion 18 and the piston 16.

In the embodiment, the second radially extending portion 18 includes a cylindrical axially bulging portion 55 that bulges toward the first axial direction A1. In the example, the axially bulging portion 55 is shaped to be more or less thick in the axial direction and the radial direction. The axially bulging portion 55 is formed in a radially outer region of the second radially extending portion 18. The radially outer portion of the axially bulging portion 55 overlaps the rotor Ro as seen in the axial direction. The radially inner portion of the axially bulging portion 55 overlaps the clutch drum 15 as seen in the axial direction. The axially bulging portion 55 is disposed to overlap the third bearing B3 and the second coil end portion Ce2 as seen in the radial direction. In the embodiment, the oil collection portion OC is provided at an end portion of the axially bulging portion 55 on the side in the first axial direction A1. The oil collection portion OC is provided on the side in the first axial direction A1, which is the side of the second support wall 32, with respect to the rotor Ro, and collects oil supplied via the third oil passage opening portion 31. The oil collected by the oil collection portion OC is supplied to the coil end portions Ce1 and Ce2 on both sides in the axial direction to cool the coil end portions Ce1 and Ce2. This will be discussed in detail later.

The axially extending portion 19 is shaped to extend at least in the axial direction. In the embodiment, the axially extending portion 19 extends in the axial direction and the circumferential direction. The axially extending portion 19 has the shape of a cylinder that surrounds the clutch CL from the radially outer side. The axially extending portion 19 couples a radially outer end portion of the first radially extending portion 17 and a radially outer end portion of the second radially extending portion 18 to each other in the axial direction. In the example, the axially extending portion 19 is formed integrally with the first radially extending portion 17 at an end portion of the axially extending portion 19 on the side in the second axial direction A2. In addition, the axially extending portion 19 is coupled to the second radially extending portion 18 by fastening members such as bolts at an end portion of the axially extending portion 19 on the side in the first axial direction A1. These components may be coupled to each other by welding or the like. The rotor Ro of the rotary electric machine MG is fixed to the outer peripheral portion of the axially extending portion 19.

In the embodiment, the axially extending portion 19 includes a cylindrical inner support portion 56 extending in the axial direction, and an annular one-side support portion 57 extending radially outward from an end portion of the inner support portion 56 on the side in the first axial direction A1. In the example, the one-side support portion 57 is shaped to be more or less thick in the axial direction and the radial direction. The rotor Ro is fixed in contact with the outer peripheral surface of the inner support portion 56. The inner support portion 56 thus supports the rotor Ro from the radially inner side. In addition, the rotor Ro is fixed in contact with an end surface of the one-side support portion 57 on the side in the second axial direction A2. The one-side support portion 57 thus supports the rotor Ro from the side in the first axial direction A1. An annular rotor holding member 58 is inserted from the side in the second axial direction A2 with respect to the rotor Ro to be fitted onto the inner support portion 5. The rotor holding member 58 is disposed in contact with the rotor Ro from the side in the second axial direction A2 to hold the rotor Ro from the side in the second axial direction A2. In the example, the rotor holding member 58 presses the rotor Ro from the side in the second axial direction A2 to hold the rotor Ro with the plurality of magnetic steel sheets held between the rotor holding member 58 and the one-side support portion 57.

In the embodiment, a rotation sensor 59 is provided on the side in the second axial direction A2 with respect to the rotor support member 12 and between the first support wall 25 and the first radially extending portion 17. The rotation sensor 59 is a sensor that detects the rotational position of the rotor Ro with respect to the stator St of the rotary electric machine MG. A resolver or the like, for example, may be used as the rotation sensor 59. In the embodiment, the rotation sensor 59 is disposed radially outwardly of the first bearing B1, which is disposed between the first support wall 25 and the first radially extending portion 17, to overlap the first bearing B1 as seen from the radial direction. In addition, the rotation sensor 59 is disposed radially inwardly of the stator St to overlap the first coil end portion Ce1 of the stator St as seen from the radial direction. In the example, as shown in FIG. 1, a sensor rotor 60 is fixed to a side surface of the first radially extending portion 17 on the side in the second axial direction A2, and a sensor stator 61 is fixed to a side surface of the first support wall 25 on the side in the first axial direction A1. In the embodiment, the sensor rotor 60 is disposed radially outwardly of the sensor stator 61.

### 3. Cooling of Clutch by Using First Oil Passage and Second Oil Passage

In the embodiment, oil supplied through the first oil passage L1 is supplied to the oil circulation chamber 11 to cool the plurality of friction plates 10 disposed in the oil circulation chamber 11. After cooling the friction plates 10, the oil is discharged from the oil circulation chamber 11 through the second oil passage L2. In the embodiment, the oil circulation chamber 11 functions as the “housing oil chamber” according to the present invention.

As described above, the rotor support member 12 according to the embodiment is configured to also function as a housing that houses the clutch CL (clutch housing). As shown in FIG. 1, of the space formed inside the rotor support member 12, most of the space excluding the working oil chamber H1 serves as the oil circulation chamber 11 described earlier. In the embodiment, moreover, oil that has been discharged from the oil pump 43 and regulated to a predetermined hydraulic pressure by the hydraulic pressure control device 51 is supplied to the oil circulation chamber 11 via the oil circulation passage L1a forming the first oil passage L1. In the embodiment, an oil cooler 91 is provided in the first oil passage L1 extending from the hydraulic pressure control device 51. Oil from the first oil passage L1 is cooled by the oil cooler 91, and thereafter supplied to the oil circulation chamber 11.

Here, in the embodiment, the second bearing B2 disposed between the cylindrical portion 13 of the first radially extending portion 17 and the input shaft I is a bearing with a sealing function (here, a needle bearing with a seal ring) configured to secure a certain degree of liquid tightness. Further, the inner peripheral surface of a part of the cylindrical portion 54 of the second radially extending portion 18 in the axial direction abuts against the outer peripheral surface of the intermediate shaft M over the entire circumference. Therefore, the oil circulation chamber 11 in the rotor support member 12 is liquid-tightly sealed, and basically filled with oil at a predetermined pressure or more by being supplied with oil. Thus, in the hybrid drive device H according to the embodiment, the plurality of friction plates 10 provided in the clutch CL can be effectively cooled with a large amount of oil filling the oil circulation chamber 11.

Most of the oil discharged from the oil circulation chamber 11 is discharged from the oil discharge passage L2a formed inside the intermediate shaft M via a discharge through hole 83 extending in the radial direction to open in the outer peripheral surface of the input shaft I to be returned to the oil pan 62. In the embodiment, a portion of the oil circulation chamber 11 positioned radially outwardly of the discharge through hole 83 of the input shaft I, the discharge through hole 83, a gap between the input shaft I and the intermediate shaft M, and the oil discharge passage L2a form the “second oil passage L2” according to the present invention.

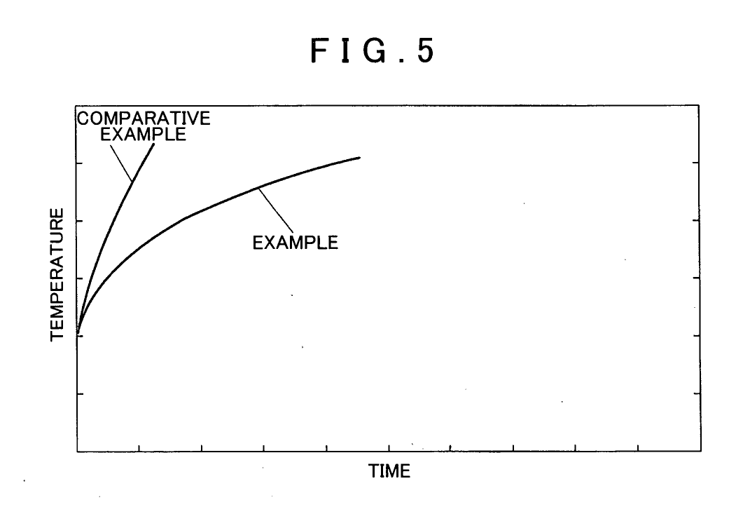

FIG. 5 shows the results of an experiment conducted to verify the effect of cooling the clutch CL in the hybrid drive device H according to the embodiment. Here, variations in temperature of the friction plates 10 over time in the case where the oil pump 43 was driven at a constant rotational speed were measured while controlling an operation of the clutch CL such that the plurality of friction plates 10 slid with respect to each other. In FIG. 5, the curve indicated as “Example” corresponds to data measured by the hybrid drive device H according to the embodiment. Meanwhile, data indicated as “Comparative Example” corresponds to data measured by a drive device in which the inside of the rotor support member 12 which houses the clutch CL is not oil-tightly sealed (in the example, with the first radially extending portion 17 removed). The same conditions were used for both Example and Comparative Example except for the presence or absence of the first radially extending portion 17.

As can be well understood from the graph of FIG. 5, with the drive device according to Comparative Example, the temperature of the friction plates was raised in a relatively short period of time. This is considered to be because oil supplied to the friction plates flowed radially outward through the friction plates so immediately that the entirety of the friction plates could not be sufficiently cooled. With the hybrid drive device H according to Example, in contrast, it is seen that the raise in temperature of the friction plates 10 was suppressed within a predetermined range even after a certain period of time elapsed. This is considered to be because the oil circulation chamber 11 was filled with oil discharged from the oil pump 43 to be supplied to the oil circulation chamber 11 via the hydraulic pressure control device 51 and the first oil passage L1 so that the oil in the oil circulation chamber 11 contacted the entirety of the friction plates 10 to effectively cool the friction plates 10.

With the drive device according to Comparative Example, in order to secure sufficient capability to cool the friction plates, it is necessary to supply a large amount of oil to the friction plates per unit time. For this purpose, however, it is necessary to provide the drive device with a relatively large oil pump. As a result, not only energy for driving the pump is increased but also the weight of the oil pump itself is increased, which may reduce the energy efficiency. In this respect, with the hybrid drive device H according to the embodiment, it is only necessary to supply a relatively small amount of oil in order to secure sufficient capability to cool the friction plates 10. Accordingly, it is not necessary to increase the size of the oil pump 43, which makes it possible to suppress a reduction in energy efficiency.

The second oil passage L2 communicates with a side surface of the second bearing B2, which is disposed between the input shaft I and the cylindrical portion 13 of the first radially extending portion 17, on the side in the first axial direction A1. Therefore, a part of oil discharged from the oil circulation chamber 11 through the second oil passage L2 passes through the second bearing B2 and leaks out in the axial direction to be supplied to the first bearing B1 disposed radially outwardly of the second bearing B2. More specifically, oil having passed through the second bearing B2 and leaked out to the second axial direction A2 passes through a fifth oil passage L5, which is formed by a space defined by the cylindrical portion 13, the input shaft I, the seal member 52, and the first support wall 25 and a space defined by the first support wall 25 and the first radially extending portion 17, and flows vertically downward to lubricate and cool the first bearing B1. In the embodiment, the side in the first axial direction A1 functions as the “one side in the axial direction” according to the present invention, and the side in the second axial direction A2 functions as the “other side in the axial direction” according to the present invention.

### 4. Cooling of Rotary Electric Machine by Using Third Oil Passage

In the embodiment, oil supplied through the third oil passage L3 is supplied to the rotary electric machine housing space S to cool the rotary electric machine MG housed in the rotary electric machine housing space S. The configuration of the working oil passage L3 and the cooling structure for the rotary electric machine MG will be described in this order below.

4-1. Configuration of Third Oil Passage

The configuration of the third oil passage L3 according to the embodiment will be described with reference to FIGS. 1 and 3. The third oil passage L3 is an oil passage through which oil is supplied to the rotary electric machine housing space S. In the embodiment, the third oil passage L3 is formed to be branched from the first oil passage L1 which allows communication from the hydraulic pressure control device 51 to the oil circulation chamber 11. In the embodiment, the third oil passage L3 is branched from the first oil passage L1 at a location downstream of the oil cooler 91. In addition, the third oil passage L3 is formed to allow communication from the first oil passage L1 to the third oil passage opening portion 31 which supplies oil to the rotary electric machine housing space S.

The third oil passage L3 is formed to be branched from the first oil passage L1 at a location in the radially extending portion 42, or at a location upstream of the radially extending portion 42 (between the hydraulic pressure control device 51 and the radially extending portion 42), in the case 20. In the embodiment, the third oil passage L3 is branched from the first oil passage L1 at a location downstream of the hydraulic pressure control device 51 and upstream of the radially extending portion 42. By thus forming the third oil passage L3 as an oil passage branched from the first oil passage L1, oil flowing through the third oil passage L3 is at the same hydraulic pressure and the oil temperature as those of oil flowing through the first oil passage L1 (that is, oil supplied to the oil circulation chamber 11).

The third oil passage L3 and the third oil passage opening portion 31 are provided in the second support wall 32. In the embodiment, both the third oil passage L3 and the third oil passage opening portion 31 are provided in the radially extending portion 42 forming the second support wall 32. In the example, an introduction port 44 (see FIG. 3) is provided in the vicinity of the outer edge portion of the radially extending portion 42 on the lower side in the vertical direction. The introduction port 44 opens in the radially extending portion 42 on the side of the speed change mechanism TM, that is, toward the first axial direction A1. An oil passage which is a part of the third oil passage L3 and which is branched from the first oil passage L1 is connected to the introduction port 44. A seal member (not shown) is provided on a mating surface of the case 20 at a connection portion between the introduction port 44 and the oil passage branched from the first oil passage L1 to allow oil-tight connection therebetween. The introduction port 44 communicates with the oil supply passage L3a provided in the radially extending portion 42.

As shown in FIGS. 1 and 3, the oil supply passage L3a extends linearly radially inward from the introduction port 44 to a position radially inwardly of the oil collection portion OC. Moreover, the third oil passage opening portion 31 which opens toward the side of the rotary electric machine MG, that is, toward the second axial direction A2, is provided at the position of a radially inner end portion of the oil supply passage L3a. The third oil passage opening portion 31 is provided between the body portion 41 and the oil collection portion OC in the radial direction, that is, at a position radially outwardly of the body portion 41 and radially inwardly of the oil collection portion OC. In this way, the third oil passage L3 is formed to allow communication from the first oil passage L1, from which it is branched, to the third oil passage opening portion 31 via the oil supply passage L3a. Thus, oil from the hydraulic pressure control device 51 passes through the upstream side of the first oil passage L1 and thereafter passes through the third oil passage L3 branched from the first oil passage L1 to be supplied from the third oil passage opening portion 31 provided in the radially extending portion 42 toward the side of the rotary electric machine MG.

Here, as described above, the supply communication hole 23 is formed in the radial wall portion 21 disposed adjacent to the radially extending portion 42 on the side in the second axial direction A2, that is, on the side of the rotary electric machine MG. The supply communication hole 23 is formed at a position overlapping the third oil passage opening portion 31 as seen in the axial direction. In the example, the third oil passage opening portion 31 and the supply communication hole 23 are formed to have the same inside diameter as each other and have their inner peripheral surfaces matching each other so that the third oil passage opening portion 31 and the supply communication hole 23 completely overlap each other as seen in the axial direction. Therefore, oil passing through the third oil passage L3 to be supplied from the third oil passage opening portion 31 further passes through the supply communication hole 23 to be supplied toward the side of the rotary electric machine MG.

The third oil passage opening portion 31 opens toward the side of the rotary electric machine MG, that is, toward the second axial direction A2. A ring-shaped throttle member 34 is disposed in contact with the inner peripheral surface of the third oil passage opening portion 31. A throttle hole 36 with a small diameter is formed in the throttle member 34. Oil having passed through the throttle hole 36 is supplied toward the side of the rotary electric machine MG via the third oil passage opening portion 31. In this event, the rate of oil supplied from the third oil passage opening portion 31 (here, specifically the throttle hole 36) rises with respect to the flow rate of oil in the third oil passage L3. This allows the oil supplied from the third oil passage opening portion 31 to be appropriately supplied toward the side of the rotary electric machine MG through the supply communication hole 23 provided in the radial wall portion 21, even in the case where the rotational speed of the intermediate shaft M is reduced to reduce the flow rate of the oil in the third oil passage L3. Oil having passed through the radial wall portion 21 to reach the side of the rotary electric machine MG flows vertically downward to be supplied to the rotary electric machine housing space S.

In the embodiment, the rotary electric machine MG and the speed change mechanism TM are disposed side by side in the axial direction with the second support wall 32 interposed therebetween, and the hydraulic pressure control device 51 is disposed at a position overlapping the speed change mechanism TM as seen from the radial direction. Moreover, as discussed above, the third oil passage L3 branched from the first oil passage L1 is provided in the second support wall 32 (in the example, the radially extending portion 42) positioned relatively close to the hydraulic pressure control device 51 and disposed adjacent to the rotary electric machine MG on the side in the first axial direction A1. Accordingly, the overall length of an oil passage from the hydraulic pressure control device 51 to the third oil passage opening portion 31 of the third oil passage L3 is shortened. Thus, the configuration of the third oil passage L3 can be simplified.

4-2. Cooling Structure for Rotary Electric Machine

Next, the cooling structure for the rotary electric machine MG according to the embodiment will be described. The rotary electric machine MG according to the embodiment is basically structured such that the coil end portions Ce1 and Ce2 are cooled by oil supplied from the third oil passage L3 disposed on the side in the first axial direction A1 with respect to the rotor Ro.

As shown in FIG. 1, the third oil passage opening portion 31 is provided at a position radially inwardly of the oil collection portion OC. Thus, oil supplied (spouted) from the third oil passage opening portion 31 to be supplied to the rotary electric machine housing space S is collected by the oil collection portion OC disposed radially outwardly of (here, vertically below) the third oil passage opening portion 31 to be finally supplied to the coil end portions Ce1 and Ce2 of the stator St disposed radially outwardly of the rotor support member 12.

In the embodiment, the oil collection portion OC is provided at an end portion, on the side in the first axial direction A1, of the axially bulging portion 55 of the second radially extending portion 18 forming a part of the rotor support member 12. More specifically, the oil collection portion OC is formed as a pocket-like space formed between a recessed portion 75 that is dented toward the second axial direction A2 with respect to an end surface 55a of the axially bulging portion 55 on the side in the first axial direction A1 and that opens radially inward, and a covering member 76 fixed in contact with the end surface 55a of the axially bulging portion 55 on the side in the first axial direction A1. A plurality of such oil collection portions OC are disposed at a plurality of locations in the circumferential direction to be distributed at equal intervals. Each of the oil collection portions OC is closed on both sides in the axial direction, both sides in the circumferential direction, and the radially outer side, and opens only radially inward. The oil collection portion OC can efficiently collect and store oil supplied from the third oil passage opening portion 31.

The rotary electric machine MG according to the embodiment is structured such that the coil end portions Ce1 and Ce2 are cooled utilizing the oil collected and stored by the oil collection portion OC. Therefore, the rotary electric machine MG according to the embodiment includes two oil passages (a first cooling oil passage L4a and a second cooling oil passage L4b) that are formed in both the rotor Ro and the rotor support member 12 and that respectively communicate with two opening portions (that is, a first opening portion P1 that opens toward the second axial direction A2 and a second opening portion P2 that opens toward the first axial direction A1) formed to extend from the oil collection portion OC to both sides of the rotor Ro in the axial direction. The first cooling oil passage L4a extends from the oil collection portion OC to communicate with the first opening portion P1 provided radially inwardly of the first coil end portion Ce1. The second cooling oil passage L4b extends from the oil collection portion OC to communicate with the second opening portion P2 provided radially inwardly of the second coil end portion Ce2. The first cooling oil passage L4a and the second cooling oil passage L4b are formed to be common to each other partially on the upstream side (on side of the oil collection portion OC). In the embodiment, the first cooling oil passage L4a and the second cooling oil passage L4b form the “fourth oil passage L4” according to the present invention.

In the embodiment, the first cooling oil passage L4a includes a portion extending along the axial direction in the one-side support portion 57 of the axially extending portion 19, and a portion extending in the axial direction along a joint surface between the inner peripheral surface of the rotor Ro and the outer peripheral surface of the inner support portion 56. In the example, the portion extending in the axial direction along the joint surface between the inner peripheral surface of the rotor Ro and the outer peripheral surface of the inner support portion 56 is formed as a space between the outer peripheral surface of the inner support portion 56 and an axial groove portion 73 formed on the radially inner side of the rotor Ro. The second cooling oil passage L4b is formed to be branched from the first cooling oil passage L4a to extend radially outward in the one-side support portion 57.

In the rotary electric machine MG configured as described above, the coil end portions Ce1 and Ce2 are cooled as follows. First, oil supplied from the third oil passage opening portion 31 provided on the side in the first axial direction A1 with respect to the rotor Ro is supplied to the rotary electric machine housing space S to be collected by the oil collection portion OC in the rotary electric machine housing space S. The oil collected by the oil collection portion OC is supplied from the oil collection portion OC to the first cooling oil passage L4a. A part of the oil supplied to the first cooling oil passage L4a is spouted from the first opening portion P1 on the side in the second axial direction A2, and showers on the first coil end portion Ce1 disposed radially outwardly of the first opening portion P1 to cool the first coil end portion Ce1. Another part of the oil supplied to the first cooling oil passage L4a is spouted from the second opening portion P2 on the side in the first axial direction A1 through the second cooling oil passage L4b branched from the first cooling oil passage L4a, and showers on the second coil end portion Ce2 disposed radially outwardly of the second opening portion P2 to cool the second coil end portion Ce2. After cooling the coil end portions Ce, the oil is returned to the oil pan 62 shown in FIG. 4.

In this event, the third oil passage opening portion 31 is supplied with oil through the third oil passage L3 branched from the first oil passage L1 which supplies oil to the oil circulation chamber 11 which houses the clutch CL. Therefore, the temperature of the oil finally supplied to the coil end portions Ce (Ce1 and Ce1) from the third oil passage opening portion 31 is about the same as the temperature of the oil supplied to the oil circulation chamber 11. Moreover, oil passing through the first oil passage L1 and the third oil passage L3 has been cooled by the oil cooler 91 at a location downstream of the hydraulic pressure control device 51 and upstream of a branch point between the first oil passage L1 and the third oil passage L3, and thereafter is directly supplied to the oil circulation chamber 11 and the coil end portions Ce, respectively, without cooling other members. Thus, the oil temperature remains relatively low. Accordingly, the rotary electric machine MG can be effectively cooled by oil from the third oil passage L3 while sufficiently cooling the clutch CL with oil from the first oil passage L1.

The hybrid drive device H according to the embodiment includes the cooling structure for the clutch CL and the cooling structure for the rotary electric machine MG described above. Thus, it is possible to efficiently cool both the clutch CL and the rotary electric machine MG while suppressing the amount of oil supplied from the oil pump 43 to be small.

### 5. Other Embodiments

Lastly, vehicle drive devices according to other embodiments of the present invention will be described. A characteristic configuration disclosed in each of the following embodiments may be applied not only to that particular embodiment but also in combination with a characteristic configuration disclosed in any other embodiment unless any contradiction occurs.

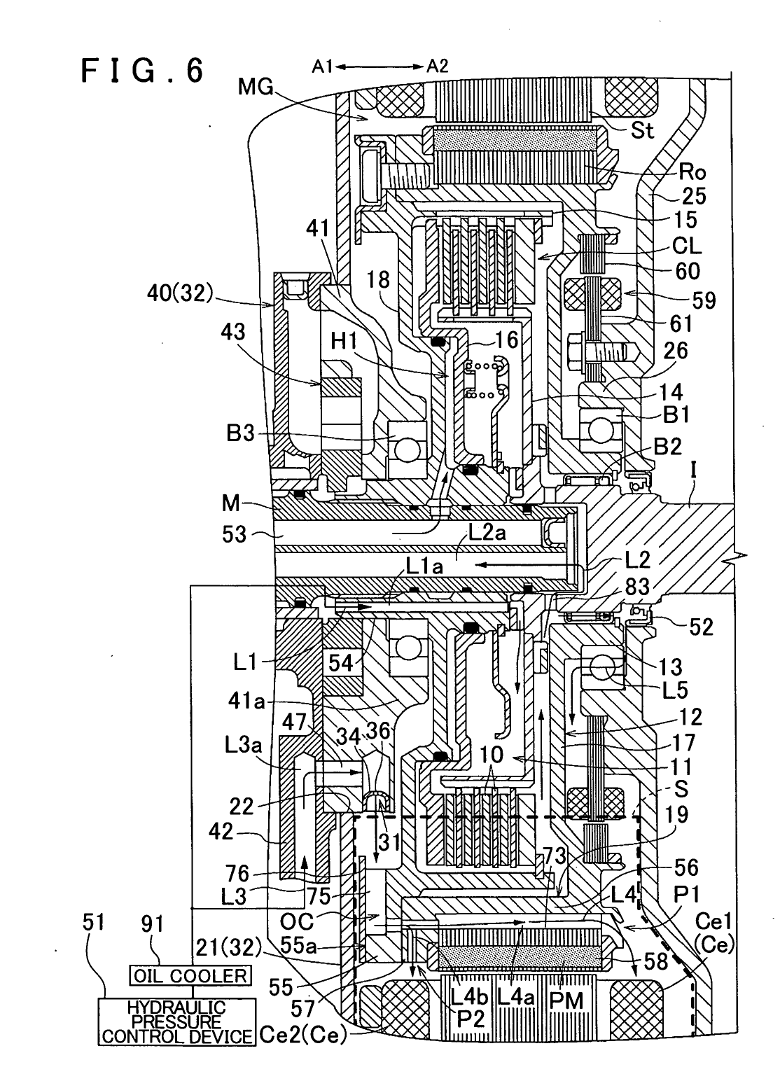

(1) In the embodiment described above, both the third oil passage L3 and the third oil passage opening portion 31 are provided in the radially extending portion 42 of the pump case 40, and the third oil passage opening portion 31 opens toward the side of the rotary electric machine MG. However, the present invention is not limited thereto. Thus, as shown in FIG. 6, for example, the third oil passage opening portion 31 may be provided in the body portion 41 on the side of the rotary electric machine MG with respect to the radial wall portion 21, and the third oil passage L3 may be configured to allow communication from the first oil passage L1, from which the third oil passage L3 is branched, to the third oil passage opening portion 31 provided in the body portion 41 through the radially extending portion 42.

In the example shown, as in the embodiment described above, the oil supply passage L3a, which is a part of the third oil passage L3 branched from the first oil passage L1, is formed to extend in the radially extending portion 42 from the radially outer side toward the radially inner side. In the example, the oil supply passage L3a extends to a location radially inwardly of the outer peripheral surface of the body portion 41. The oil supply passage L3a communicates, at its radially inner end portion, with a communication hole 47 provided in the body portion 41 via an opening portion that opens toward the side in the second axial direction A2. The communication hole 47 extends in the body portion 41 in the axial direction and is bent radially outward at a position on the side in the second axial direction A2 with respect to the radial wall portion 21 to be connected to the third oil passage opening portion 31 provided in the outer peripheral portion of the body portion 41. The oil supply passage L3a and the third oil passage opening portion 31 provided in the body portion 41 thus communicate with each other via the communication hole 47. The third oil passage opening portion 31 is formed to open radially outward in the outer peripheral surface of the body portion 41. The third oil passage opening portion 31 is also formed on the side in the second axial direction A2 with respect to the radial wall portion 21 and at a position overlapping the oil collection portion OC as seen in the radial direction. With such a configuration, oil flowing through the third oil passage L3 passes inside the radially extending portion 42 and the body portion 41 to be directly supplied from the third oil passage opening portion 31 to the rotary electric machine housing space S. The oil supplied to the rotary electric machine housing space S is supplied to the oil collection portion OC, passes through the fourth oil passage L4, and thereafter cools the coil end portions Ce.

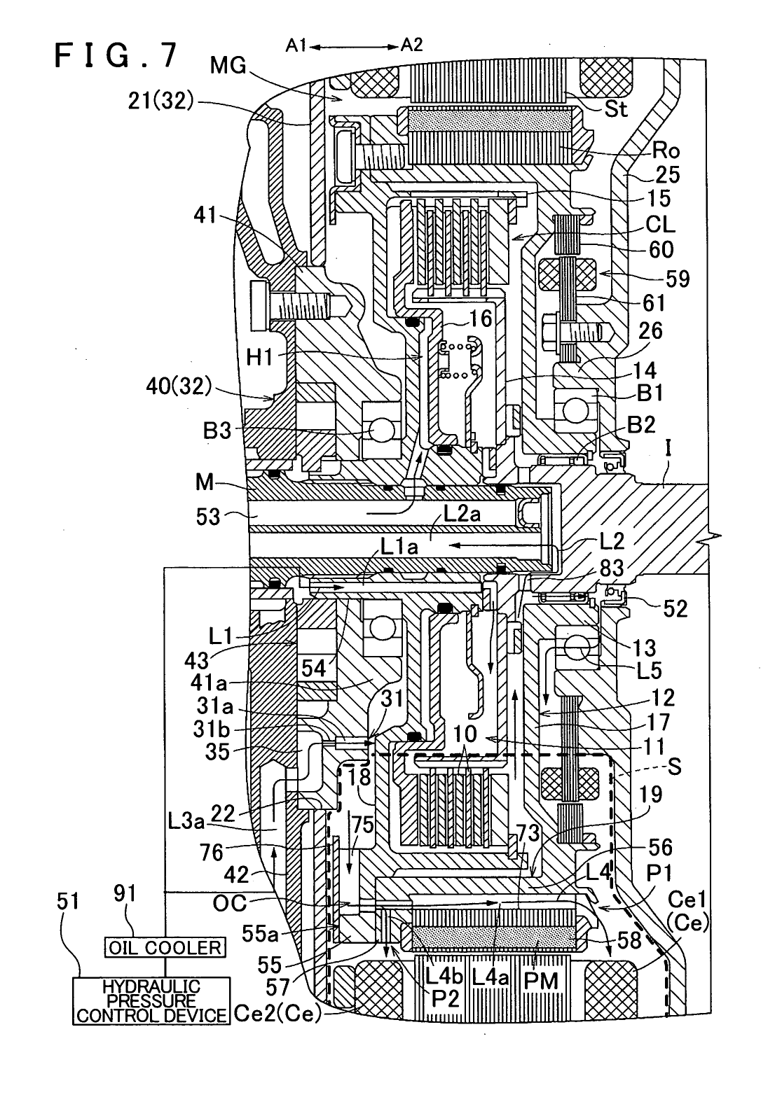

(2) Alternatively, in the case where the third oil passage opening portion 31 is provided in the body portion 41, as shown in FIG. 7, the third oil passage opening portion 31 may be formed to open toward the second axial direction A2 in a side surface of the body portion 41 on the side in the second axial direction A2.

In the example shown, the oil supply passage L3a communicates, at its radially inner end portion, with a recessed portion 35 provided in an end surface of the body portion 41 on the side in the first axial direction A1 via an opening portion that opens toward the side in the second axial direction A2. The recessed portion 35 is dented toward the second axial direction A2 with respect to an end surface of the body portion 41 on the side in the first axial direction A1, and formed to open toward the first axial direction A1. The recessed portion 35 communicates with the third oil passage opening portion 31 formed to open toward the second axial direction A2. The oil supply passage L3a and the third oil passage opening portion 31 provided in the body portion 41 thus communicate with each other via the recessed portion 35. The third oil passage opening portion 31 is provided at a position on the side in the second axial direction A2 with respect to the oil collection portion OC. With such a configuration, oil flowing through the third oil passage L3 passes inside the radially extending portion 42 and the body portion 41 and is supplied from the third oil passage opening portion 31 toward the second axial direction A2 to be supplied to the rotary electric machine housing space S. The oil supplied to the rotary electric machine housing space S is supplied to the oil collection portion OC positioned vertically below the third oil passage opening portion 31 by flowing along the second radially extending portion 18 or the like, passes through the fourth oil passage L4, and thereafter cools the coil end portions Ce.

Here, the third oil passage opening portion 31 includes a third oil passage opening portion first region 31a and a third oil passage opening portion second region 31b arranged in this order from the side in the second axial direction A2 toward the side in the second axial direction A1. The inside diameter of the third oil passage opening portion second region 31b is smaller than the inside diameter of the third oil passage opening portion first region 31a and the inside diameter of the third oil passage L3. That is, the third oil passage opening portion second region 31b has a function equivalent to that of the throttle hole 36 of the throttle member 34 in the embodiment described above.

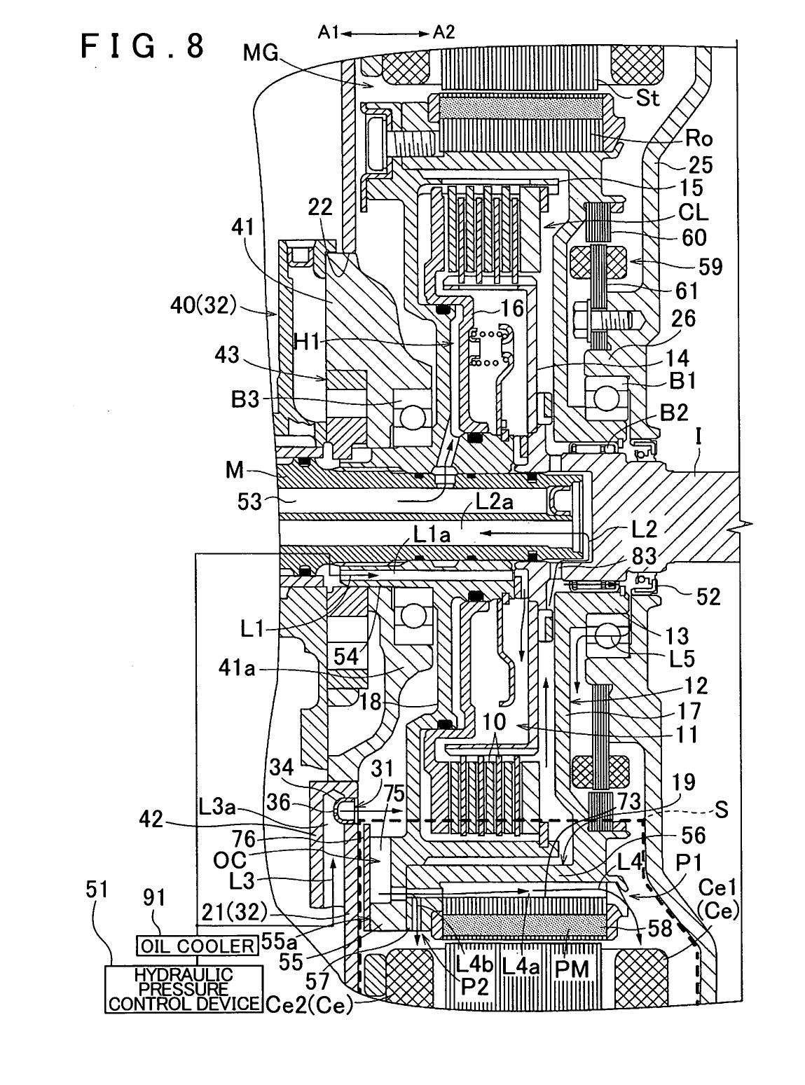

(3) In the embodiment described above, both the oil supply passage L3a and the third oil passage opening portion 31 are provided in the radially extending portion 42. However, the present invention is not limited thereto. Thus, as shown in FIG. 8, for example, both the oil supply passage L3a and the third oil passage opening portion 31 may be formed in the radial wall portion 21.

In the example shown, the oil supply passage L3a, which is a part of the third oil passage L3 branched from the first oil passage L1, is formed to extend inside the radially extending portion 21, which is formed to be more or less thick in the axial direction, from the radially outer side toward the radially inner side. The oil supply passage L3a extends to a location radially inwardly of the oil collection portion OC. The third oil passage opening portion 31 is formed at a radially inner end portion of the oil supply passage L3a to open toward the second axial direction A2. Accordingly, the third oil passage opening portion 31 is positioned radially inwardly of the oil collection portion OC. Also in the example, the ring-shaped throttle member 34, in which the throttle hole 36 with a small diameter is formed, is disposed in contact with the inner peripheral surface of the third oil passage opening portion 31. With such a configuration, oil flowing through the third oil passage L3 is supplied from the third oil passage opening portion 31 to the rotary electric machine housing space S. The oil supplied to the rotary electric machine housing space S is supplied to the oil collection portion OC, directly or indirectly by flowing vertically downward along the second radially extending portion 18 or the like, passes through the fourth oil passage L4, and thereafter cools the coil end portions Ce.

(4) In the embodiment described above, the third oil passage L3 and the third oil passage opening portion 31 are provided in the second support wall 32. However, the present invention is not limited thereto. Thus, the third oil passage L3 may be provided between the second support wall 32 and the cylindrical portion 54 of the second radially extending portion 18, for example.

In the example, the first oil passage L1 passes through a location radially inwardly of the inner rotor of the oil pump 43, which is splined to the cylindrical portion 54, between the hydraulic pressure control device 51 and the oil circulation passage L1a (see FIG. 1), which is a part of the first oil passage L1. Oil flowing through the first oil passage L1 flows through the oil circulation passage L1a, and a part of the oil flows through a minute gap in the radial direction formed between the inner peripheral surface of the through hole of the body portion 41 and the outer peripheral surface of the cylindrical portion 54 so that only a small amount of the oil is supplied toward the second axial direction A2, that is, toward the rotary electric machine MG. That is, in the example, the minute gap functions as the “third oil passage” according to the present invention. The oil supplied through the minute gap lubricates the third bearing B3 disposed adjacent to the minute gap on the side in the second axial direction A2. The oil having lubricated the third bearing B3 flows vertically downward along the second radially extending portion 18 to be supplied to the rotary electric machine housing space S. The oil supplied to the rotary electric machine housing space S is supplied to the oil collection portion OC, passes through the fourth oil passage L4, and thereafter cools the coil end portions Ce.

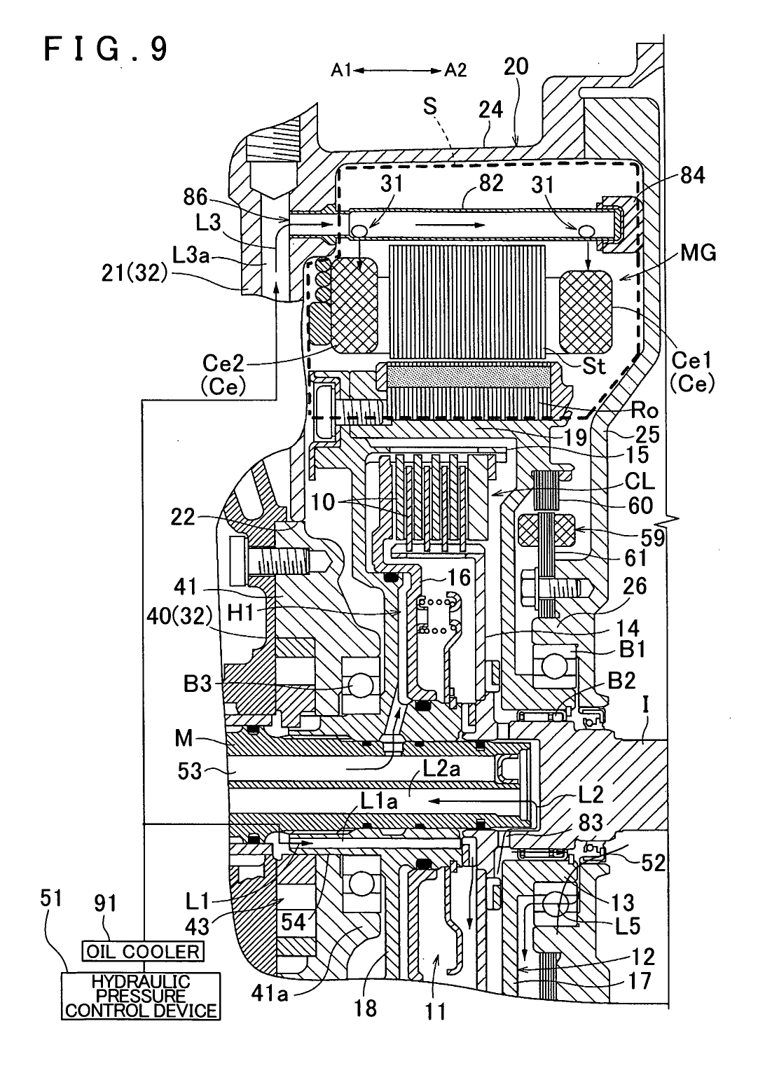

(5) In the embodiment described above, the entirety of the third oil passage L3 and the third oil passage opening portion 31 is provided in the second support wall 32. However, the present invention is not limited thereto. Thus, as shown in FIG. 9, for example, a pipe 82 extending in the axial direction from the second support wall 32 may be provided vertically above the stator St so that a space in the pipe 82 forms a part of the third oil passage L3.

In the example shown, the oil supply passage L3a, which is a part of the third oil passage L3 branched from the first oil passage L1, is formed to extend inside the radially extending portion 21 from the radially inner side toward the radially outer side. The oil supply passage L3a extends to a position radially outwardly of the stator St. An in-wall opening portion 86 that opens toward the second axial direction A2 is formed in a radially outer end portion of the oil supply passage L3a.

The pipe 82, which extends linearly along the axial direction and an end portion of which on the side in the second axial direction A2 is sealed, is fitted with the in-wall opening portion 86. An end portion of the pipe 82 on the side in the second axial direction A2 is supported by a pipe support portion 84 provided on the first support wall 25. The pipe support portion 84 is provided vertically above the stator St on a side surface of the first support wall 25 on the side in the first axial direction A1. A recessed portion that opens toward the first axial direction A1 is formed in the pipe support portion 84. An end portion of the pipe 82 on the side in the second axial direction A2 is inserted into the recessed portion to support the pipe 82. In this way, the pipe 82 is fixed vertically above the stator St by the in-wall opening portion 86 and the pipe support portion 84.

The pipe 82 is provided with two separate third oil passage opening portions 31 at positions respectively overlapping the coil end portions Ce1 and Ce2 as seen in the radial direction. With such a configuration, oil flowing through the third oil passage L3 is directly supplied from the third oil passage opening portions 31 to the coil end portions Ce1 and Ce2 disposed in the rotary electric machine housing space S to cool the coil end portions Ce1 and Ce2. In the example, the third oil passage opening portions 31 are disposed radially outwardly of a radially inner end portion of the rotor Ro. Thus, the rotary electric machine housing space S is a space that is spread radially outwardly of the rotor support member 12 and that occupies a region between a radially inner end portion of the rotor Ro and the case peripheral wall 24 in the radial direction. In the example, the third oil passage opening portions 31 are provided only above the coil end portions Ce1 and Ce2. However, a third oil passage opening portion 31 may be additionally provided above the stator core of the stator St so that the entirety of the stator St including the stator core and the coil end portions Ce1 and Ce2 can be cooled.

(6) In the embodiment described above, the third oil passage L3 is branched from the first oil passage L1 at a location between the hydraulic pressure control device 51 and the radially extending portion 42. However, the present invention is not limited thereto. Thus, the third oil passage L3 may be branched from the first oil passage L1 at any position such as in the radially extending portion 42, in the case peripheral wall 24, or in the hydraulic pressure control device 51, for example. Alternatively, the third oil passage L3 may be formed independently of the first oil passage L1. In the case where the third oil passage L3 is branched from the first oil passage L1 in the hydraulic pressure control device 51 or in the case where the third oil passage L3 is formed independently of the first oil passage L1, the hydraulic pressure of oil flowing through the third oil passage L3 may be controlled to a hydraulic pressure different from that of oil flowing through the first oil passage L1.

(7) In the embodiment described above, the oil collection portion OC is provided in the second radially extending portion 18 (axially bulging portion 55) of the rotor support member 12. However, the present invention is not limited thereto. Thus, in one preferred embodiment of the present invention, the oil collection portion OC may be provided in a side surface of the rotor Ro (here, including the rotor core forming the rotor Ro and the rotor holding member such as an end plate that presses the rotor Ro in the axial direction to hold the rotor Ro).

(8) In the embodiment described above, the hybrid drive device H is of a multi-axis configuration which is suitable in the case where the hybrid drive device H is mounted on a FF (Front-Engine Front-Drive) vehicle. However, the present invention is not limited thereto. That is, in one preferred embodiment of the present invention, the hybrid drive device H may be of a single-axis configuration in which the output shaft of the speed change mechanism TM is disposed coaxially with the input shaft I and the intermediate shaft M and directly drivably coupled to the output differential gear device DF. Such a configuration is suitable in the case where the hybrid drive device H is mounted on a FR (Front-Engine Rear-Drive) vehicle.

(9) Also regarding other configurations, the embodiment disclosed herein is illustrative in all respects, and the present invention is not limited thereto. That is, it is a matter of course that a configuration obtained by appropriately altering part of a configuration not described in the claims of the present invention also falls within the technical scope of the present invention as long as the resulting configuration includes a configuration described in the claims or a configuration equivalent thereto.

The present invention may be suitably applied to a vehicle drive device including an input member drivably coupled to an internal combustion engine, an output member drivably coupled to wheels, a friction engagement device that selectively drivably couples the input member and the output member to each other, and a rotary electric machine provided on a power transfer path connecting between the input member and the output member.

1-9. (canceled)

10. A vehicle drive device, comprising:
an input member drivably coupled to an internal combustion engine;
an output member drivably coupled to wheels;
a friction engagement device that selectively drivably couples the input member and the output member to each other;
a rotary electric machine provided on a power transfer path connecting between the input member and the output member;
a housing oil chamber that houses at least friction members of the friction engagement device and that is filled with oil;
a housing space that houses the rotary electric machine;
a first oil passage through which oil is supplied to the housing oil chamber;
a second oil passage through which oil is discharged from the housing oil chamber; and
a third oil passage through which oil is supplied to the housing space.

11. The vehicle drive device according to claim 10, wherein
the third oil passage is formed to be branched from the first oil passage.

12. The vehicle drive device according to claim 10, further comprising:
a case that houses at least the rotary electric machine and the friction engagement device, wherein:
a rotor of the rotary electric machine is disposed radially inwardly of a stator of the rotary electric machine;
the third oil passage is provided in the case, and includes a third oil passage opening portion that opens inside the case; and
the third oil passage opening portion is positioned radially inwardly of an outer peripheral surface of the rotor.

13. The vehicle drive device according to claim 11, further comprising:
a case that houses at least the rotary electric machine and the friction engagement device, wherein:
a rotor of the rotary electric machine is disposed radially inwardly of a stator of the rotary electric machine;
the third oil passage is provided in the case, and includes a third oil passage opening portion that opens inside the case; and
the third oil passage opening portion is positioned radially inwardly of an outer peripheral surface of the rotor.

14. The vehicle drive device according to claim 12, further comprising:
a speed change mechanism disposed coaxially with the rotary electric machine and side by side with the rotary electric machine in an axial direction; and
a hydraulic pressure control device disposed at a position overlapping the speed change mechanism as seen from a radial direction, wherein:
the case includes a partition wall extending in a radial direction of the rotary electric machine for partitioning between the rotary electric machine and the speed change mechanism;
the first oil passage allows communication from the hydraulic pressure control device to the housing oil chamber; and
the third oil passage opening portion is provided in the partition wall.

15. The vehicle drive device according to claim 13, further comprising:
a speed change mechanism disposed coaxially with the rotary electric machine and side by side with the rotary electric machine in an axial direction; and
a hydraulic pressure control device disposed at a position overlapping the speed change mechanism as seen from a radial direction, wherein:
the case includes a partition wall extending in a radial direction of the rotary electric machine for partitioning between the rotary electric machine and the speed change mechanism;
the first oil passage allows communication from the hydraulic pressure control device to the housing oil chamber; and
the third oil passage opening portion is provided in the partition wall.

16. The vehicle drive device according to claim 12, further comprising:
an oil collection portion provided in the rotor or a support member for the rotor; and
a fourth oil passage through which oil is supplied from the oil collection portion to a coil end portion of the stator, wherein
the third oil passage opening portion is positioned on an inner side of the oil collection portion in a radial direction of the rotor.

17. The vehicle drive device according to claim 14, further comprising:
an oil collection portion provided in the rotor or a support member for the rotor; and
a fourth oil passage through which oil is supplied from the oil collection portion to a coil end portion of the stator, wherein
the third oil passage opening portion is positioned on an inner side of the oil collection portion in a radial direction of the rotor.

18. The vehicle drive device according to claim 13, further comprising:
an oil collection portion provided in the rotor or a support member for the rotor; and
a fourth oil passage through which oil is supplied from the oil collection portion to a coil end portion of the stator, wherein
the third oil passage opening portion is positioned on an inner side of the oil collection portion in a radial direction of the rotor.

19. The vehicle drive device according to claim 15, further comprising:
an oil collection portion provided in the rotor or a support member for the rotor; and
a fourth oil passage through which oil is supplied from the oil collection portion to a coil end portion of the stator, wherein
the third oil passage opening portion is positioned on an inner side of the oil collection portion in a radial direction of the rotor.

20. The vehicle drive device according to claim 10, further comprising:
a housing which surrounds the friction engagement device from both sides in the axial direction and from an outer side in the radial direction and in which the housing oil chamber is formed, wherein:
the housing also serves as a support member for the rotor of the rotary electric machine, and includes an axially projecting portion that has a shape of a cylinder and projects in the axial direction of the rotor;
an outer peripheral surface of the axially projecting portion is rotatably supported by a first bearing, and an inner peripheral surface of the axially projecting portion is rotatably supported by a second bearing with a seal;
the second bearing is disposed such that a surface of the second bearing on one side in the axial direction communicates with the second oil passage; and
a fifth oil passage through which oil having passed through the second bearing and leaked out to the other side in the axial direction is supplied to the first bearing is provided on the other side of the second bearing in the axial direction.

21. The vehicle drive device according to claim 14, wherein:
the partition wall includes a radial wall portion formed integrally with the case and a pump case that houses an oil pump;
the radial wall portion extends radially inward from an outer peripheral wall portion of the case, and includes a center opening portion that penetrates through the radial wall portion in the axial direction to open at a radially central portion of the radial wall portion;
the pump case includes a body portion disposed to be inserted into the center opening portion, and a radially extending portion extending in the radial direction on a side opposite the rotary electric machine with respect to the radial wall portion;
the third oil passage and the third oil passage opening portion are provided in the radially extending portion, and the third oil passage opening portion opens toward a side of the rotary electric machine; and
a supply communication hole that allows oil to be discharged from the third oil passage opening portion and be supplied toward the side of the rotary electric machine is formed to penetrate through the radial wall portion at a position overlapping the third oil passage opening portion as seen in an axial direction of the rotary electric machine.

22. The vehicle drive device according to claim 15, wherein:
the partition wall includes a radial wall portion formed integrally with the case and a pump case that houses an oil pump;
the radial wall portion extends radially inward from an outer peripheral wall portion of the case, and includes a center opening portion that penetrates through the radial wall portion in the axial direction to open at a radially central portion of the radial wall portion;
the pump case includes a body portion disposed to be inserted into the center opening portion, and a radially extending portion extending in the radial direction on a side opposite the rotary electric machine with respect to the radial wall portion;
the third oil passage and the third oil passage opening portion are provided in the radially extending portion, and the third oil passage opening portion opens toward a side of the rotary electric machine; and
a supply communication hole that allows oil to be discharged from the third oil passage opening portion and be supplied toward the side of the rotary electric machine is formed to penetrate through the radial wall portion at a position overlapping the third oil passage opening portion as seen in an axial direction of the rotary electric machine.

23. The vehicle drive device according to claim 14, wherein:
the partition wall includes a radial wall portion formed integrally with the case and a pump case that houses an oil pump;
the radial wall portion extends radially inward from an outer peripheral wall portion of the case, and includes a center opening portion that penetrates through the radial wall portion in the axial direction to open at a radially central portion of the radial wall portion;
the pump case includes a body portion disposed to be inserted into the center opening portion, and a radially extending portion extending in the radial direction on a side opposite the rotary electric machine with respect to the radial wall portion; and
the third oil passage is provided across the radially extending portion and the body portion, and the third oil passage opening portion is provided at a portion of the body portion on a side of the rotary electric machine with respect to the radial wall portion to open radially outward.

24. The vehicle drive device according to claim 15, wherein:
the partition wall includes a radial wall portion formed integrally with the case and a pump case that houses an oil pump;
the radial wall portion extends radially inward from an outer peripheral wall portion of the case, and includes a center opening portion that penetrates through the radial wall portion in the axial direction to open at a radially central portion of the radial wall portion;
the pump case includes a body portion disposed to be inserted into the center opening portion, and a radially extending portion extending in the radial direction on a side opposite the rotary electric machine with respect to the radial wall portion; and
the third oil passage is provided across the radially extending portion and the body portion, and the third oil passage opening portion is provided at a portion of the body portion on a side of the rotary electric machine with respect to the radial wall portion to open radially outward.

25. The vehicle drive device according to claim 14, wherein:
the partition wall includes a radial wall portion formed integrally with the case and a pump case that houses an oil pump;
the radial wall portion extends radially inward from an outer peripheral wall portion of the case, and includes a center opening portion that penetrates through the radial wall portion in the axial direction to open at a radially central portion of the radial wall portion;
the pump case includes a body portion disposed to be inserted into the center opening portion, and a radially extending portion extending in the radial direction on a side opposite the rotary electric machine with respect to the radial wall portion; and
the third oil passage and the third oil passage opening portion are provided in the radial wall portion, and the third oil passage opening portion opens toward a side of the rotary electric machine.

26. The vehicle drive device according to claim 15, wherein:
the partition wall includes a radial wall portion formed integrally with the case and a pump case that houses an oil pump;
the radial wall portion extends radially inward from an outer peripheral wall portion of the case, and includes a center opening portion that penetrates through the radial wall portion in the axial direction to open at a radially central portion of the radial wall portion;
the pump case includes a body portion disposed to be inserted into the center opening portion, and a radially extending portion extending in the radial direction on a side opposite the rotary electric machine with respect to the radial wall portion; and
the third oil passage and the third oil passage opening portion are provided in the radial wall portion, and the third oil passage opening portion opens toward a side of the rotary electric machine.
